(19) United States
(12) Patent Application Publication
(10) Pub. No.: US 2019/0384779 A1
(43) Pub. Date: Dec. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Masato ANDO, Kanagawa (JP); Tomoyuki ITO, Kanagawa (JP)

(73) Assignee: FUJI XEROX CO., LTD., Tokyo (JP)

(21) Appl. No.: 16/354,218

(22) Filed: Mar. 15, 2019

(30) Foreign Application Priority Data
Jun. 15, 2018 (JP) 2018-115010

(51) Int. Cl. G06F 16/28; G06F 16/2457; G06F 16/22; G06F 9/54

(52) U.S. Cl. CPC G06F 16/287; G06F 9/542; G06F 16/2272; G06F 16/2457

(57) ABSTRACT

An information processing apparatus includes a display unit and an output unit. The display unit displays a relations diagram in which plural items are connected to each other via arrows to represent relations between the plural items. If at least two items among the plural items are displayed at different positions but have the same or similar attributes, the output unit outputs notification information that is a notification of the attributes of the at least two items.

### CROSS-REFERENCE TO RELATED APPLICATIONS

This application is based on and claims priority under 35 USC 119 from Japanese Patent Application No. 2018-115010 filed Jun. 15, 2018.

### BACKGROUND

### (i) Technical Field

The present disclosure relates to an information processing apparatus and a non-transitory computer readable medium.

### (ii) Related Art

A known information processing apparatus is as follows (see Japanese Unexamined Patent Application Publication No. 2016-81185, for example). In a system diagram, a plurality of function items having dependence relations are systematized by being connected to each other in accordance with the dependence relations. When creating and inputting a relations diagram with attribute information for identifying a process associated with a certain function item, the function items, the attribute information of the function items, and the dependence information of the function items are extracted from the relations diagram and stored as raw data. Subsequently, by setting axes of a spreadsheet or a contingency table, the spreadsheet or contingency table corresponding to the set axes is created by using the raw data and is output.

### SUMMARY

In a relations diagram in which a plurality of items each having an attribute such as an item name or a characteristic are connected via arrows to represent relations between the plurality of items, at least two items having the same or similar attributes may be displayed at different positions. In such a case, it is not possible to inform a user of the attributes of the at least two items.

Aspects of non-limiting embodiments of the present disclosure relate to informing the user of the attributes of the at least two items when the at least two items having the same or similar attributes are displayed at different positions in the relations diagram in which the plurality of items having attributes such as item names and characteristics are connected via arrows to represent relations between the plurality of items.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a display unit and an output unit. The display unit displays a relations diagram in which a plurality of items are connected to each other via arrows to represent relations between the plurality of items. If at least two items among the plurality of items are displayed at different positions but have the same or similar attributes, the output unit outputs notification information that is a notification of the attributes of the at least two items.

### BRIEF DESCRIPTION OF THE DRAWINGS

An exemplary embodiment of the present disclosure will be described in detail based on the following figures, wherein:

FIG. 1 is a conceptual diagram illustrating exemplary configurations of modules according to the exemplary embodiment;

FIG. 2 illustrates a data structure example of a relations diagram information table;

FIG. 3 illustrates a data structure example of an item information table;

FIG. 4 illustrates a data structure example of an arrow information table;

FIG. 5 illustrates a system configuration example using the exemplary embodiment;

FIG. 6 illustrates an example of a technique for which a relations diagram and a spreadsheet are created;

FIG. 7 illustrates an example of the relations diagram;

FIG. 8 illustrates an example of the relations diagram;

FIG. 9 illustrates an example of the relations diagram;

FIG. 10 illustrates an example of the spreadsheet;

FIG. 11 illustrates an example of a process on the relations diagram according to the exemplary embodiment;

FIG. 12 illustrates an example of a screen;

FIG. 13 is a flowchart illustrating an example of a process according to the exemplary embodiment; and

FIG. 14 illustrates an example of a hardware configuration according to the exemplary embodiment.

### DETAILED DESCRIPTION

Hereinafter, an exemplary embodiment of the present disclosure will be described in detail with reference to the attached drawings.

In a typical system using complex physical phenomena, a large number of events are linked to each other like chains. For example, a resultant event, such as a final quality of a product, may be caused by a plurality of events, which are caused by a plurality of other events, and the plurality of other events are caused by a plurality of still other events. In such a complex system, a large number of qualities need to be assured, and the cause-and-effect relations between causes and effects are extremely complex. Accordingly, it is difficult to find a design item (cause) that assures a desired quality (effect), and a change in design value for assuring a certain quality may tend to adversely affect the other qualities.

To visualize and organize such complex cause-and-effect relations, for example, a relations diagram is used. The relations diagram represents the cause-and-effect relations by connecting the effects and their causes to each other via arrows, and a logic tree is a typical example. The relations diagram is suitably used for indicating the effects and their causes in detail, without omission and repetition.

Since a large number of events are linked to and crossed with each other, a plurality of events having the same or similar attributes may be arranged apart from each other in the relations diagram in order to keep the visibility. Accordingly, for example, in a case where an attribute that is the same as or similar to the attributes of the plurality of events is input for a newly added event, it is useful to inform a user of the attribute information of the plurality of events.

Thus, according to the exemplary embodiment, in a case where a plurality of events having the same or similar attributes are arranged apart from each other, a user is informed of the attribute information of the plurality of events.

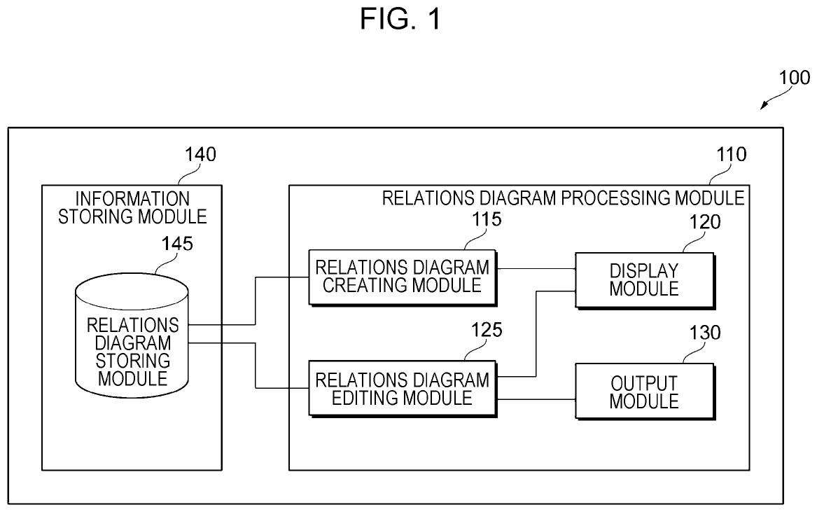

FIG. 1 is a conceptual diagram illustrating exemplary configurations of modules according to the exemplary embodiment.

Note that the term “module” generally means a logically separable component of software (computer program), hardware, or the like. Accordingly, a module in the exemplary embodiment refers to not only a module in a computer program but also a module in a hardware configuration. Therefore, the exemplary embodiment will also illustrate a computer program for realizing the function of such a module (a program for causing a computer to execute each step, a program for causing a computer to function as each unit, or a program for causing a computer to realize each function), a system therefor, and a method therefor. For the convenience of description, “store Y”, “cause X to store Y”, or a similar expression will be used. In an exemplary embodiment illustrating a computer program, such an expression means to cause a memory device (X) to store Y or to perform control in such a manner as to cause a memory device (X) to store Y. Modules and functions may correspond to each other in a one-to-one relationship. Alternatively, in implementation, a single program may realize a single module or a plurality of modules. Conversely, a plurality of programs may realize-a single module. A plurality of modules may be executed by a single computer, or a single module may be executed by a plurality of computers in a distributed or parallel environment. In addition, a single module may include another module. The term “connect” is herein used to describe a physical connection or a logical connection (e.g., data transfer, instruction transmission, or data cross-reference). The term “predetermined” means a state where something is determined prior to a target process and includes the meaning of not only being determined before the starting of a process according to the exemplary embodiment but also being determined before the target process even after the starting of a process according to the exemplary embodiment, in accordance with the present or previous status and conditions. If there are a plurality of “predetermined values”, these values may be mutually different values, or two or more values may be the same (it is needless to say that all the values may be the same). Furthermore, a list of things such as “A, B, and C” is a list of examples unless otherwise specified, and only one of them (e.g., only A) may be selected therefrom.

Furthermore, a system or a device may be configured by connecting a plurality of computers, hardware components, devices, and the like to one another by using a communication means, such as a network (including one-to-one-correspondence communication connection), or may be configured by a single computer, hardware component, device, and the like. Note that the terms “system” and “device” are used as synonyms. It may be needless to say that the term “system” does not mean a social mechanism (social system), which is settled by humans.

Furthermore, in the case where a plurality of processes are performed by the respective modules or within a module, target information is read from a memory device in each process, and after the process has been performed, the process result is written to the memory device. Accordingly, description of the reading of information from the memory device before a process and the writing of information to the memory device after the process will be omitted in some cases. Note that examples of the memory device herein may include a hard disk, a random access memory (RAM), an external memory medium, a memory device connected via a communication line, a register in a central processing unit (CPU), and the like.

An information processing apparatus 100 according to the exemplary embodiment displays relations diagrams and, as illustrated in the example in FIG. 1, includes a relations diagram processing module 110 and an information storing module 140.

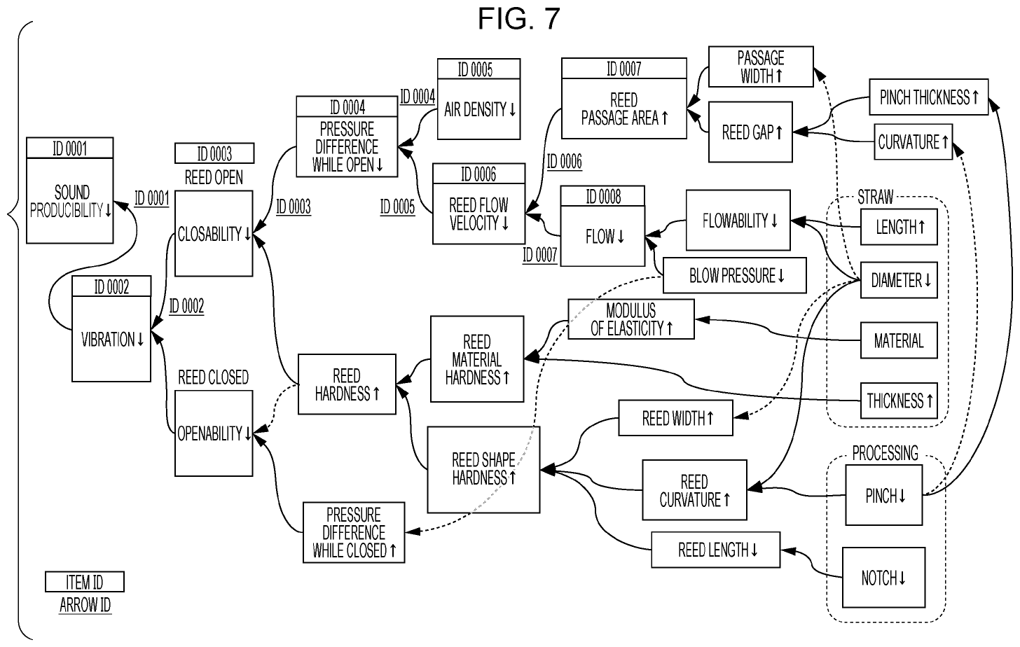

A relations diagram is used to clarify cause-and-effect relations when a problem to be addressed has been identified but causes of the problem are complex. As illustrated in FIG. 7, a relations diagram includes items and arrows.

The relations diagram processing module 110 includes a relations diagram creating module 115, a display module 120, a relations diagram editing module 125, and an output module 130. The relations diagram processing module 110 creates, edits, and displays a relations diagram.

The relations diagram creating module 115 is connected to the display module 120 and a relations diagram storing module 145 of the information storing module 140. The relations diagram creating module 115 receives information necessary to create a relations diagram. For example, the relations diagram creating module 115 receives information of a relations diagram, items, and arrows created by user operations, for example, using keys on a keyboard and a mouse, on a user interface displayed on a display device such as a liquid crystal display. The relations diagram creating module 115, not only receives user operations using keys on a keyboard and the like, but also reads information stored in a hard disk (a built-in hard disk of the computer or one connected through the network) or the like.

The display module 120 is connected to the relations diagram creating module 115 and the relations diagram editing module 125. The display module 120 displays a relations diagram created by the relations diagram creating module 115 and a relations diagram edited by the relations diagram editing module 125 on a display device such as a display. When the user performs no further operation on the display, the display module 120 may serve as an output module that prints the relations diagram by using a printing apparatus such as a printer, transmits an image by using an image transmitting apparatus such as a facsimile, writes the relations diagram in a storing apparatus such as a database, stores the relations diagram in a memory medium such as a memory card, or transfers the relations diagram to another information processing apparatus. In the exemplary embodiment, the display module 120 is provided as an example of a display means for displaying the relations diagram. In a case where an attribute of an item in the relations diagram is to be changed, the display module 120 displays the item in the relations diagram on a display device such as a display in a state where the attribute thereof is changeable. In the exemplary embodiment, the display module 120 is provided as an example of a display means for displaying any of items in a state where the attribute thereof is changeable. In addition, the display module 120 may display a single item obtained by integrating a plurality of items in the relations diagram on a display device such as a display. In the exemplary embodiment, the display module 120 is provided as an example of a display means for displaying the single item obtained by integrating several items.

The relations diagram editing module 125 is connected to the display module 120, the output module 130, and the relations diagram storing module 145 of the information storing module 140. In response to a user operation for editing the relations diagram displayed by the display module 120, the relations diagram editing module 125 edits the relations diagram. For example, in response to a user's editing operation, the relations diagram editing module 125 edits (adds or deletes) an item, edits an attribute (name, characteristic, and the like) of the item, reassigns (adds or deletes) an arrow, and edits an attribute (strength, direction, and the like) of the arrow. In addition, in response to a user operation on a screen displayed by the output module 130, the relations diagram editing module 125 displays a new item and another item separately at different positions or integrates and displays the new item and the other item at the same position. The other item is already present in the relations diagram at a position that is different from the position of the new item, but the attribute of the other item is the same as or similar to the attribute of the new item.

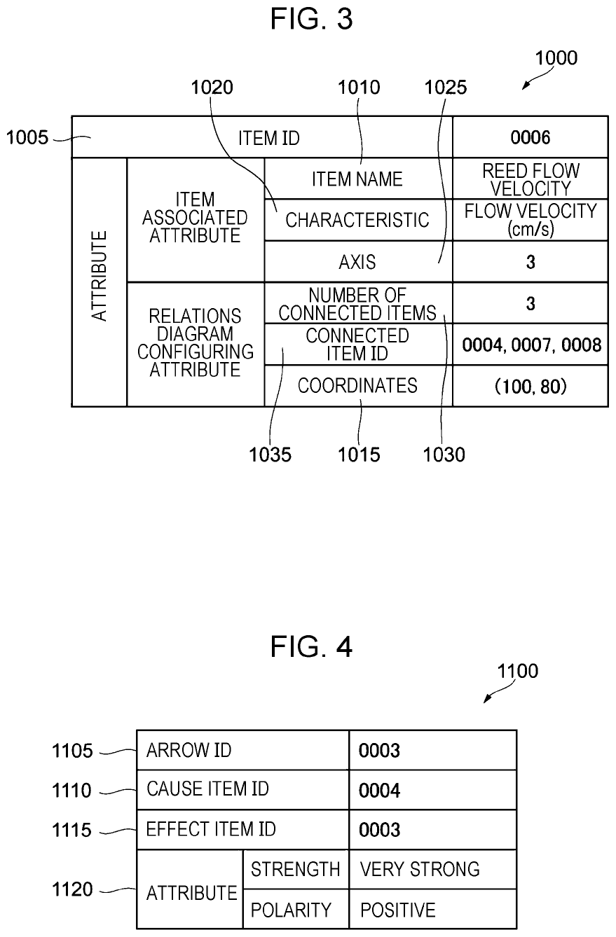

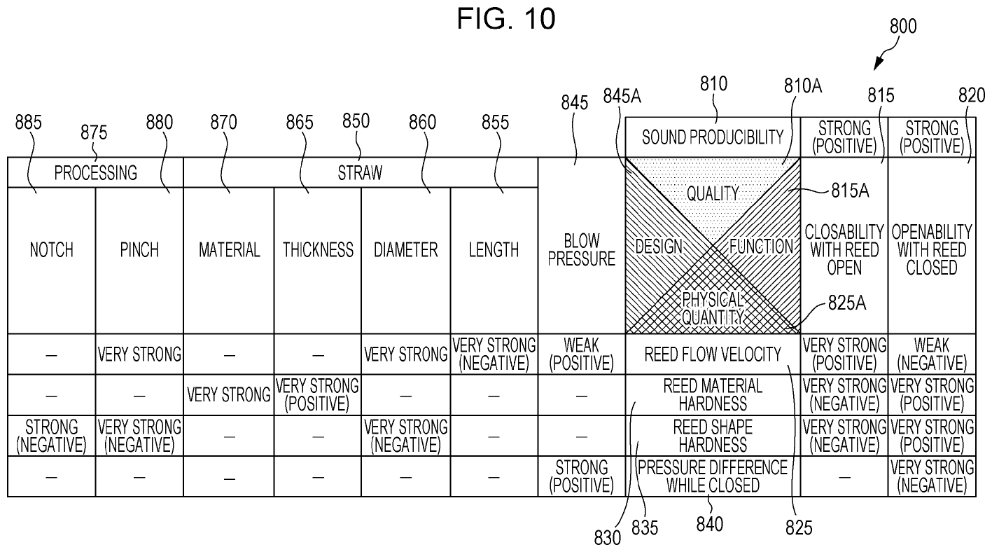

Note that the expression “items have the same attributes” herein means that all of the names and characteristics of the items and the axes associated with the items (see FIG. 3) are the same. The expression “the characteristics are the same” includes, for example, having equal values as a result of unit conversion. The expression “items have similar attributes” herein means that at least one of the names and characteristics of the items and the axes associated with the items (see FIG. 3) is similar but the others are the same. In this case, the expression “the names of the items are similar” means that the names of the items are partly the same or that one of the names of the items is rewording of the other (using a different expression without changing the meaning), for example. The expression “the characteristics are similar” means that the characteristics are partly the same, for example. The expression “the characteristics are partly the same” means that the expressions of the names of the characteristics are partly the same, as in “air flow rate” and “liquid flow rate”. In addition, similar characteristics or similar units may be stored in advance, and on the basis of these, similar characteristics may be determined. The expression “the axes associated with the items are similar” means that a difference between axes numerals is less than or equal to a predetermined value. If the predetermined value is 1, for example, axes 2 and 3 are determined as being “similar” (see FIGS. 9 and 10). Note that it may be determined that “items have similar attributes” on the basis of a standard set by a user or by executing a predetermined logic by setting standard similar patterns.

If a user adds a new item to a relations diagram and changes an attribute of the new item to an attribute that is the same as or similar to an attribute of another item that is already present in the relations diagram at a position that is different from the position of the new item, the output module 130 informs the user of information of the new item and the other item that is already present and displays a screen that inquires whether the new item and the other item that is already present are to be displayed separately at different positions or to be integrated and displayed at the same position. In the exemplary embodiment, as examples of at least two items that are displayed at different positions but have the same or similar attributes, the new item and the other item(s) that is already present are used. In addition, as an example of notification information of the attributes of the at least two items, a screen that informs the user of the information of the new item and the other item(s) that is already present is used. Furthermore, the output module 130 is provided as an example of an output means for outputting the notification information. Although the screen is displayed herein if the attribute of the new item is modified to be an attribute that is the same as or similar to the attribute of the other item that is already present in the relations diagram, the present disclosure is not limited to this technique. The screen may be displayed at any timing when it is found that a plurality of items having the same or similar attributes are present in the relations diagram. In this light, the new item is an example of an item for which the attribute is set among the at least two items.

The information storing module 140 includes the relations diagram storing module 145. The information storing module 140 stores information regarding the relations diagram.

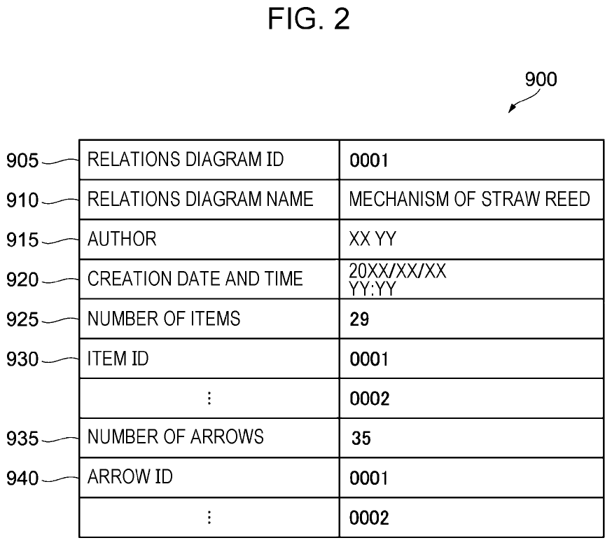

The relations diagram storing module 145 stores information of the relations diagram. Specifically, the relations diagram storing module 145 stores a relations diagram information table 900, an item information table 1000, and an arrow information table 1100. FIG. 2 illustrates a data structure example of the relations diagram information table 900. The relations diagram information table 900 includes a relations diagram ID field 905, a relations diagram name field 910, an author field 915, a creation date and time field 920, a number of items field 925, item ID fields 930, a number of arrows field 935, and arrow ID fields 940. In the exemplary embodiment, the relations diagram ID field 905 stores information for uniquely identifying a relations diagram (relations diagram identifier (ID)). The relations diagram name field 910 stores a name of the relations diagram having the relations diagram ID. The author field 915 stores an author of the relations diagram. The creation date and time field 920 stores a date and time point at which the relations diagram has been created or edited (year, month, day, hour, minute, second, decimal, or a combination thereof). The number of items field 925 stores the number of items in the relations diagram. There are as many item ID fields 930 as the number of items indicated in the number of items field 925. In the exemplary embodiment, the item ID fields 930 store information (item IDs) for uniquely identifying items. The information indicated by the item IDs is stored in the item information table 1000. The number of arrows field 935 stores the number of arrows in the relations diagram. There are as many arrow ID fields 940 as the number of arrows indicated in the number of arrows field 935. In the exemplary embodiment, the arrow ID fields 940 store information (arrow IDs) for uniquely identifying arrows. The information indicated by the arrow IDs is stored in the arrow information table 1100.

FIG. 3 illustrates a data structure example of the item information table 1000. The item information table 1000 is prepared for each item ID, and includes, as attributes, an item associated attribute that is an attribute associated with an item and a relations diagram configuring attribute that is an attribute for configuring a relations diagram. The item associated attribute is an attribute such as the name and characteristic of the item or an axis associated with the item. Note that the characteristic herein is a nature, a behavior, and an effect. The relations diagram configuring attribute is an attribute such as a number of connection items, a connection item ID, or coordinates. Along with this, the item information table 1000 includes an item ID field 1005, an item name field 1010, a coordinates field 1015, a characteristics field 1020, an axis field 1025, a number of connected items field 1030, and a connected item ID field 1035. The item ID field 1005 stores an item ID. The item name field 1010 stores a name of an item having the item ID. The coordinates field 1015 stores coordinates of the relations diagram at which the item is displayed. The characteristics field 1020 stores the characteristic of the item. The axis field 1025 stores an axis associated with an axis item corresponding to the item when the relations diagram is converted to a spreadsheet. The number of connected items field 1030 stores the number of items to which the subject item is connected. That is, the number of connected items field 1030 stores the total number of items serving as effects in a case where the subject item serves as a cause of connections and items serving as causes in a case where the subject item serves as an effect of connections. The connected item ID field 1035 stores IDs of items serving as the effects and IDs of items serving as the causes, and the number of the IDs of items is equal to the number of items indicated in the number of connected items field 1030. For example, a reed flow velocity is represented as follows: the item ID is “0006”, the item name is “reed flow velocity”, the characteristic is “flow velocity (cm/s)”, the axis is “3”, the number of connected items is “3”, the connected item IDs are “0004, 0007, 0008”, and the coordinates are “(100,80)”.

FIG. 4 illustrates a data structure example of the arrow information table 1100. The arrow information table 1100 includes an arrow ID field 1105, a cause item ID field 1110, an effect item ID field 1115, and an attribute field 1120. The arrow ID field 1105 stores an arrow ID. The cause item ID field 1110 stores an item ID of an item from which an arrow extends. The effect item ID field 1115 stores an item ID of an item to which the arrow extends. The attribute field 1120 stores an attribute of the arrow. The attribute can be, for example, a polarity of the arrow. The polarity is a nature as to whether a numeric value of an item serving as an effect increases as a numeric value of an item serving as a cause increases (e.g., in direct proportion) or whether a numeric value of an item serving as an effect decreases as a numeric value of an item serving as a cause increases (e.g., in reverse proportion). The attribute can also be, for example, the strength or direction of a relation indicated by the arrow.

FIGS. 2 to 4 illustrate examples, and other types of data structure may be used, instead. For example, the data structure of a graph may be used.

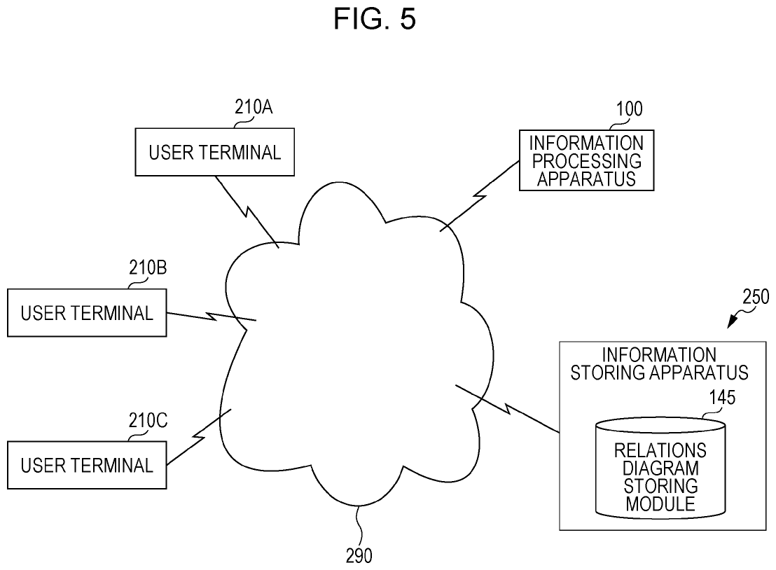

FIG. 5 illustrates a system configuration example according to the exemplary embodiment.

The information processing apparatus 100, a user terminal 210A, a user terminal 210B, a user terminal 210C, and an information storing apparatus 250 are connected to one another through a communication line 290. The communication line 290 may be a wireless or wired line or a combination of wireless and wired lines, and may be, for example, the Internet or an intranet as a communication infrastructure. Functions of the information processing apparatus 100 and the information storing apparatus 250 may be achieved as a cloud service. The information storing apparatus 250 includes the relations diagram storing module 145. The information processing apparatus 100 may use, as the relations diagram storing module 145, the relations diagram storing module 145 of the information storing apparatus 250 through the communication line 290.

The information processing apparatus 100 creates a relations diagram in accordance with a user operation using the user terminal 210A, for example. Information of the relations diagram is stored in the relations diagram storing module 145 of the information storing apparatus 250 through the communication line 290.

The information processing apparatus 100 edits the relations diagram in accordance with a user operation using the user terminal 210B, for example. In particular, if a new item is added and its attribute is set in the relations diagram from the user terminal 210B, the information processing apparatus 100 displays a screen including information of the new item and another item having the same attribute or a similar attribute, which is already present in the relations diagram, on the user terminal 210B.

The user terminals 210A to 2100 may include the information processing apparatus 100. In this case, a standalone system is established.

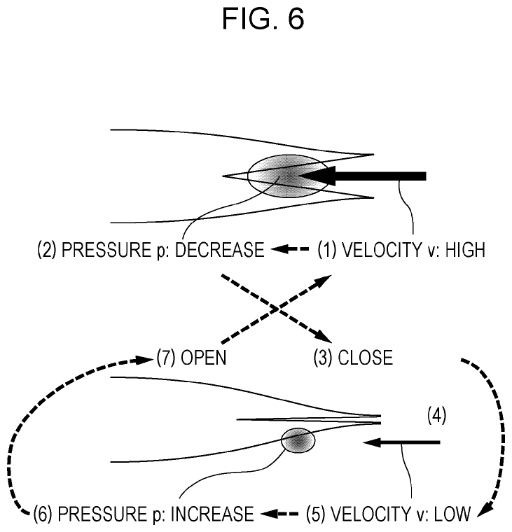

Next, with reference to FIGS. 6 to 10, an example of a mechanism of a straw reed will be described, in which a relations diagram is created and a spreadsheet is generated.

FIG. 6 illustrates an example of a technique (the mechanism of the straw reed) for which a relations diagram and a spreadsheet are created.

A principle in fluid dynamics stating that an increase in the speed of a fluid occurs simultaneously with a decrease in pressure, which is Bernoulli's principle (refer to expression (1)), is used.

p+½ρν²=constant(p: pressure,r: density,v: velocity) (1)

Vibration of the straw reed can be explained as follows. Numbers below correspond to numbers indicated in FIG. 6.

(1) Blowing of air increases the flow velocity inside the straw.

(2) Increase in the flow velocity decreases the pressure.

(3) Decrease in pressure causes the reed to be closed.

(4) Closing of the reed narrows the passage.

(5) Narrowing of the passage decreases the flow velocity.

(6) Decrease in the flow velocity increases the pressure to its original value.

(7) When the pressure returns to its original value, the reed opens, and the process returns to (1).

FIG. 7 illustrates an example of a relations diagram. FIG. 7 illustrates an example of a relations diagram of a mechanism of a straw reed that does not produce sound. The relations diagram is created by the relations diagram creating module 115 in accordance with a user operation.

It is assumed here that the density of air does not vary and a way of pinching the straw is not determined.

In the example in FIG. 7, items defined by rectangles are connected to each other by arrows. Upward arrows inside the item indicate that there are upward changes in the items, and downward arrows indicate that there are downward changes in the items.

Colors of the arrows connecting the items to each other indicate the polarity of cause-and-effect relations. Solid arrows connecting the items to each other indicate that there are positive correlations, and dashed arrows connecting the items to each other indicate that there are negative correlations. If an item “vibration” decreases, for example, an item “sound producibility” also decreases. In addition, levels of effects of cause-and-effect relations may be indicated by the thickness or the like of lines. These pieces of information are stored in the attribute field 1120 of the arrow information table 1100.

Although the item IDs and the arrow IDs are indicated in the relations diagram in FIG. 7, the item IDs and the arrow IDs may be hidden from the relations diagram that is actually displayed on a screen.

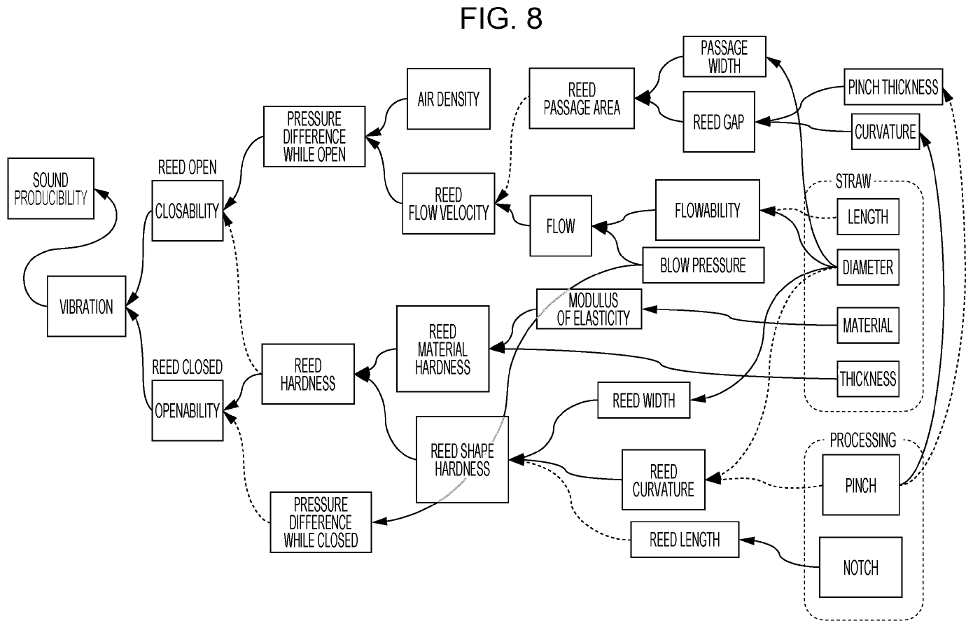

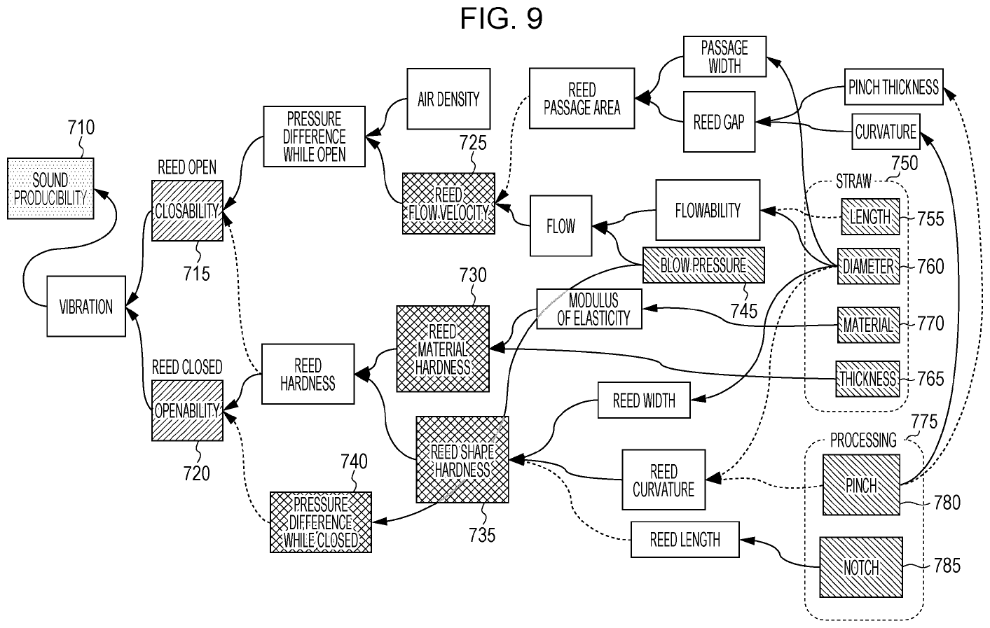

FIG. 8 illustrates another example of the relations diagram. The relations diagram illustrated in FIG. 8 is obtained by changing all the items in the relations diagram illustrated in the example in FIG. 7 to upward factors. That is, FIG. 8 illustrates an example of a relations diagram of sound producibility. As a result, some positive correlations change to negative correlations, and some negative correlations change to positive correlations, among the arrows connecting the items to each other.

FIG. 9 illustrates still another example of the relations diagram.

FIG. 9 illustrates an example in which items to be used as axes (axis items) of a spreadsheet have been selected through a user operation. Here, a first axis is quality, a second axis is a function, a third axis is a physical quantity, and a fourth axis is a design.

An item (sound producibility) 710 has been selected as the first axis.

An item (closability with reed open) 715 and an item (openability with reed closed) 720 have been selected as the second axis.

An item (reed flow velocity) 725, an item (reed material hardness) 730, an item (reed shape hardness) 735, and an item (pressure difference while open) 740 have been selected as the third axis.

An item (blow pressure) 745, an item (length) 755, an item (diameter) 760, an item (thickness) 765, an item (material) 770, an item (pinch) 780, and an item (notch) 785 have been selected as the fourth axis.

These pieces of information of the selected axes are stored in the axis field 1025 of the item information table 1000.

FIG. 10 illustrates an example of a spreadsheet. FIG. 10 illustrates a spreadsheet generated from the relations diagram illustrated in the example in FIG. 9. That is, FIG. 10 illustrates an example of a spreadsheet of the sound producibility of the straw reed.

A target of a spreadsheet is the entirety or a part of a system to be developed or designed.

A first axis (quality) 810A indicates a quality, that is, an indicator of a value of which a customer is assured. The first axis (quality) 810A is an indicator of a value obtained when a system (component) that is a target of a spreadsheet achieves a function thereof and an indicator of a value of which a customer is assured by the system or a higher system. The first axis (quality) 810A includes an axis item (sound producibility) 810.

A second axis (function) 815A indicates a role achieved by a component or a subsystem of a system in order to produce a quality. The second axis (function) 815A includes an axis item (closability with reed open) 815 and an axis item (openability with reed closed) 820.

A third axis (physical quantity) 825A indicates a physical quantity by which the function achieved by a component or a subsystem is determined. The third axis (physical quantity) 825A includes an axis item (reed flow velocity) 825, an axis item (reed material hardness) 830, an axis item (reed shape hardness) 835, and an axis item (pressure difference while closed) 840.

A fourth axis (design) 845A indicates setting conditions for controlling the physical quantity of a target component or subsystem and quantities and conditions that can be determined (to be determined) by a designer or a developer. The fourth axis (design) 845A includes an axis item (blow pressure) 845, an axis item (straw) 850, and an axis item (processing) 875. The axis item (straw) 850 includes an axis item (length) 855, an axis item (diameter) 860, an axis item (thickness) 865, and an axis item (material) 870. The axis item (processing) 875 includes an axis item (pinch) 880 and an axis item (notch) 885.

Cells (rectangles in which “VERY STRONG” or the like is written in the example illustrated in FIG. 10) whose positions are determined in adjacent axis items of a spreadsheet include cause-and-effect information. The cause-and-effect information indicates a cause-and-effect relation between two axis items. Signs “VERY STRONG”, “STRONG”, and “WEAK” indicate degrees of effects of the cause-and-effect relations, and accompanying signs “(POSITIVE)” and “(NEGATIVE)” indicate the polarity of cause-and-effect relations. That is, “(POSITIVE)” indicates a positive correlation, “(NEGATIVE)” indicates a negative correlation, “VERY STRONG (POSITIVE)” indicates a very strong positive correlation, “WEAK (POSITIVE)” indicates a weak positive correlation, “VERY STRONG (NEGATIVE)” indicates a very strong negative correlation, “WEAK (NEGATIVE)” indicates a weak negative correlation, and “−” indicates no correlation. A relation between the axis item (sound producibility) 810 and the axis item (closability with reed open) 815, for example, is “VERY STRONG (POSITIVE)”. These pieces of information reflect the attributes stored in the attribute field 1120 of the arrow information table 1100.

Now, a process for adding a new item to a relations diagram will be described. Note that an item name will be described below as an example of an attribute to be modified when the new item is added, and the following description will be given on the assumption that the new item and another item that is already present have the same item names as an example of having the same or similar item names. Note that this process is not limited to a process for the item name but may be a process for an attribute corresponding to an item ID, such as the item name, coordinates, characteristic, axis, number of connected items, or connected item ID.

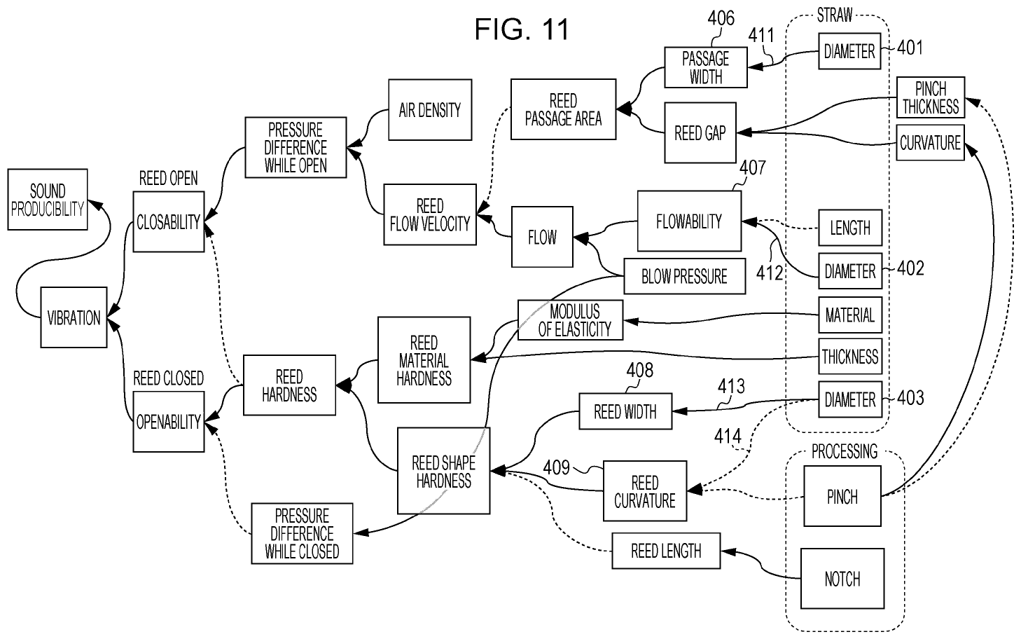

FIG. 11 illustrates an example of a process on the relations diagram according to the exemplary embodiment.

In FIG. 11, a user performs an editing operation in which a new item is added to a relations diagram and an item name of the new item is modified to be the same as an item name of another item that is already present at a position different from the position of the new item in the relations diagram. For example, the user is editing an item (diameter) 401 and connecting the item (diameter) 401 to an item (passage width) 406 via an arrow 411. On the other hand, an item (diameter) 402 and an item (diameter) 403 having the same item name as the item (diameter) 401 are already present in the relations diagram, the item (diameter) 402 is connected to an item (flowability) 407 via an arrow 412, and the item (diameter) 403 is connected to an item (reed width) 408 and an item (read curvature) 409 via arrows 413 and 414.

Upon such an editing operation, the user is informed of information of an editing item and other items having the same item name, the other items being already present at positions different from the position of the editing item in the relations diagram. In addition, a screen is displayed for inquiring whether these items are separately displayed at different positions or are integrated and displayed at the same position.

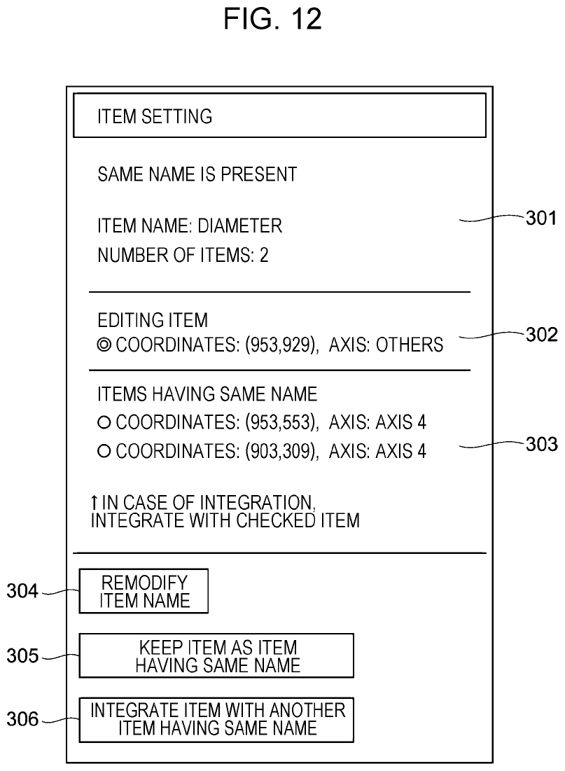

FIG. 12 illustrates an example of the screen.

In a display region 301, in addition to information indicating that the other items having the same item name as the editing item are already present, as attributes of the editing item and the other items having the same item name, the item names and the number of items having the same name, which is the number of the other items having the same name, are displayed. For example, “diameter” is displayed as the item name, and “2” is displayed as the number of items having the same name.

In a display region 302, as the attribute of the editing item, coordinates of the item and an axis associated with the item are displayed.

In a selection region 303, as the attributes of the editing item and the other items having the same item name, coordinates of the items and the axes associated with the items are displayed, in a state where an item with which the editing item is to be integrated from among the other items is selectable in a case of integration. Note that the information displayed in the selection region 303 is an example of information for selecting several items from among at least two items.

A button 304 and a button 305 are operated by a user when displaying the editing item and the other items having the same item name separately at different positions, the other items being already present at positions different from the position of the editing item in the relations diagram. Note that, in other words, the button 304 and the button 305 can inform the user that the editing item and the other items having the same item name can be displayed separately at different positions, the other items being already present at positions different from the position of the editing item in the relations diagram. In this light, the button 304 and the button 305 are each an example of first notification information that is a notification stating that it is possible to allow at least two items to be displayed at different positions.

Among them, the button 304 is operated by the user when the editing item and the other items having the same item name are displayed separately at different positions by remodifying the item name of the editing item, the other items being already present at positions different from the position of the editing item in the relations diagram. For example, when the editing item is the item (diameter) 401, upon the button 304 being pressed, the item name “diameter” of the item (diameter) 401 is displayed in a state where remodifying is possible, and when the item name “diameter” is remodified to another item name, the item 401 is added under the other item name. Note that, in other words, the button 304 can inform the user that the editing item and the other items having the same item name can be displayed separately at different positions by remodifying the item name of the editing item, the other items being already present at positions different from the position of the editing item in the relations diagram. In this light, the button 304 is an example of information that is a notification stating that it is possible to allow at least two items to be displayed at different positions by changing an attribute of any of the at least two items.

In addition, the button 305 is operated by the user when the editing item and the other items having the same item name are displayed separately at different positions by keeping the editing item as an item having the same name, the other items being already present at positions different from the position of the editing item in the relations diagram. For example, when the editing item is the item (diameter) 401, upon the button 305 being pressed, the item (diameter) 401 is added under the item name “diameter”. Note that, in other words, the button 305 can inform the user that the editing item and the other items having the same item name can be displayed separately at different positions by keeping the editing item as an item having the same name, the other items being already present at positions different from the position of the editing item in the relations diagram. In this light, the button 305 is an example of information that is a notification stating that it is possible to allow at least two items to be displayed at different positions by changing none of attributes of the at least two items.

A button 306 is operated by the user when the editing item and the other items having the same item name are integrated and displayed, the other items being already present at positions different from the position of the editing item in the relations diagram. For example, when the editing item is the item (diameter) 401, upon the button 306 being pressed, the item (diameter) 401 is integrated with an item selected from among the item (diameter) 402 and the item (diameter) 403 in the selection region 303. That is, if the item (diameter) 402 is selected in the selection region 303, any one of the item (diameter) 401 and the item (diameter) 402 is displayed, and the displayed item is connected to the item (passage width) 406 and the item (flowability) 407 via the arrows 411 and 412. In addition, if the item (diameter) 403 is selected in the selection region 303, any one of the item (diameter) 401 and the item (diameter) 403 is displayed, and the displayed item is connected to the item (passage width) 406, the item (reed width) 408, and the item (read curvature) 409 via the arrows 411, 413, and 414. Furthermore, if both the item (diameter) 402 and the item (diameter) 403 are selected in the selection region 303, any one of the item (diameter) 401, the item (diameter) 402, and the item (diameter) 403 is displayed, and the displayed item is connected to the item (passage width) 406, the item (flowability) 407, the item (reed width) 408, and the item (read curvature) 409 via the arrows 411, 412, 413, and 414. Note that, in other words, the button 306 can inform the user that the editing item and the other items having the same item name can be kept from being displayed separately at different positions, the other items being already present at positions different from the position of the editing item in the relations diagram. In this light, the button 306 is an example of second notification information that is a notification stating that it is possible not to allow at least two items to be displayed at different positions. The button 306 is also an example of information that is a notification stating that it is possible not to allow at least two items to be displayed at different positions by integrating several items from among the at least two items.

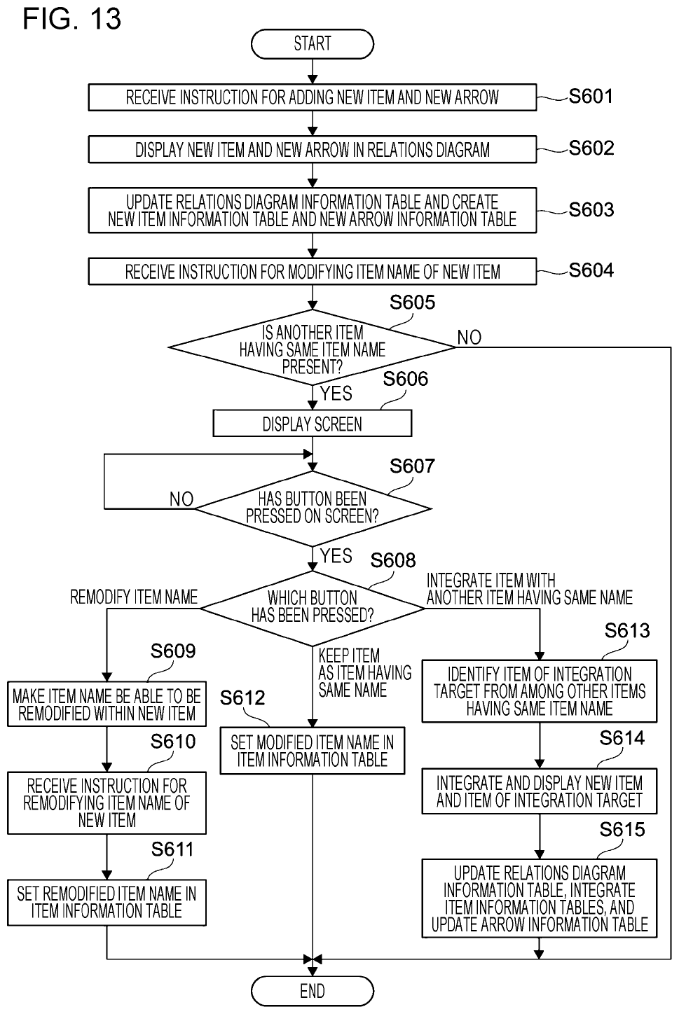

FIG. 13 is a flowchart illustrating an example of a process according to the exemplary embodiment.

First, the relations diagram editing module 125 of the information processing apparatus 100 receives an instruction for adding a new item and a new arrow to the relations diagram (step S601).

Thus, the display module 120 displays, in the relations diagram, the new item and the new arrow for which the adding instruction has been received in step S601 (step S602).

In addition, the relations diagram editing module 125 updates the relations diagram information table 900 in the relations diagram storing module 145 and creates the item information table 1000 for the new item and the arrow information table 1100 for the new arrow in the relations diagram storing module 145 (step S603). For example, in the relations diagram information table 900 with respect to the relations diagram, an item ID of the new item is set in the item ID fields 930, and an arrow ID of the new arrow is set in the arrow ID fields 940. In addition, the item information table 1000 is created in which the item ID of the new item is set in the item ID field 1005, coordinates of the new item are set in the coordinates field 1015, and an item ID of an item that is connected via the new arrow is set in the connected item ID field 1035. At this time, a provisional item name is set in the item name field 1010. In addition, the arrow information table 1100 is created in which the arrow ID of the new arrow is set in the arrow ID field 1105, an item ID of a cause item of the new arrow is set in the cause item ID field 1110, and an item ID of an effect item of the new arrow is set in the effect item ID field 1115.

Subsequently, the relations diagram editing module 125 receives an instruction for modifying the item name of the new item for which the adding instruction has been received in step S601 (step S604).

Thus, the relations diagram editing module 125 determines whether another item having the same item name as the modified item name, for which the modifying instruction has been received in step S604, is present among items that are already present in the relations diagram (step S605). If it is determined that another item having the same item name as the modified item name is present among the items that are already present in the relations diagram, the output module 130 displays the screen illustrated in FIG. 12 (step S606). In addition, the relations diagram editing module 125 determines whether a button has been pressed on the screen (step S607). If the relations diagram editing module 125 does not determine that a button has been pressed on the screen, the step S607 is repeated. If it is determined that a button has been pressed on the screen, the relations diagram editing module 125 determines which button has been pressed (step S608).

First, a case will be described in which the relations diagram editing module 125 determines that the button 304 in FIG. 12 has been pressed. In this case, the display module 120 displays the new item for which the adding instruction has been received in step S601 in a state where the item name can be remodified within the item (step S609). When the user remodifies the item name, the relations diagram editing module 125 receives the remodified item name (step S610). Thus, the remodified item name is displayed within the new item. In addition, the relations diagram editing module 125 sets the remodified item name in the item information table 1000 (step S611). That is, the remodified item name is set in place of the provisional item name in the item name field 1010 of the item information table 1000.

Second, a case will be described in which the relations diagram editing module 125 determines that the button 305 in FIG. 12 has been pressed. In this case, the relations diagram editing module 125 sets, in the item information table 1000, the item name that is modified in response to the modifying instruction that has been received in step S604 (step S612). That is, the modified item name is set in place of the provisional item name in the item name field 1010 of the item information table 1000.

Third, a case will be described in which the relations diagram editing module 125 determines that the button 306 in FIG. 12 has been pressed. In this case, the relations diagram editing module 125 identifies an item of an integration target from among other items having the same item name as the modified item name (step S613). The item of the integration target may be identified on the basis of the user's selection operation in the selection region 303. Thus, the display module 120 integrates and displays the new item for which the adding instruction has been received in step S601 and the item of the integration target that has been identified in step S613 (step S614). In addition, the relations diagram editing module 125 updates the relations diagram information table 900, integrates the item information tables 1000, and updates the arrow information table 1100 (step S615). For example, one of an item ID of the new item and an item ID of the item of the integration target, which are set in the item ID fields 930 of the relations diagram information table 900, is selected, and the item ID that is not selected is deleted. In addition, the item information table 1000 for the new item and the item information table 1000 for the item of the integration target are converted to a single item information table 1000 in which the selected item ID is set in the item ID field 1005, the modified item name is set in the item name field 1010, coordinates of the integrated item are set in the coordinates field 1015, and item IDs of all items connected to the integrated item are set in the connected item ID field 1035. Furthermore, an item ID set in the cause item ID field 1110 or the effect item ID field 1115 in each of a plurality of arrow information tables 1100 is changed in accordance with reassignment of an arrow.

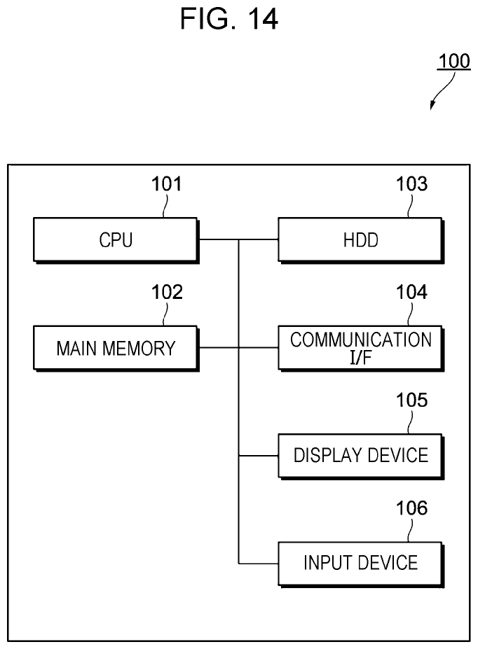

FIG. 14 illustrates an example of a hardware configuration according to the exemplary embodiment.

The information processing apparatus 100 includes a CPU 101 that is a computation means and a main memory 102 and a hard disk drive (HDD) 103 that are storage means. Note that the CPU 101 executes an operating system (OS) and various kinds of software such as applications to realize the above-described processing modules. In addition, the main memory 102 stores the various kinds of software and data, for example, to be used for their execution, and the HDD 103 stores data to be input to the various kinds of software, data output from the various kinds of software, for example. Either one or both of them realize the storing modules. The information processing apparatus 100 further includes a communication interface (communication I/F) 104 for external communication, a display device 105 such as a display, and an input device 106 such as a keyboard or a mouse.

The process performed by the information processing apparatus 100 in the exemplary embodiment is prepared, for example, as a program such as application software.

That is, a program that realizes the exemplary embodiment is also regarded as a program that enables a computer to implement: a function of displaying a relations diagram in which a plurality of items are connected to each other via arrows to represent relations between the plurality of items; and a function of outputting, if at least two items among the plurality of items are displayed at different positions but have the same or similar attributes, notification information that is a notification of the attributes of the at least two items.

Note that the program realizing the exemplary embodiment may be provided by a communication means or may be provided by being stored in a recording medium such as a CD-ROM.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a display unit that displays a relations diagram in which a plurality of items are connected to each other via arrows to represent relations between the plurality of items; and
an output unit that outputs, if at least two items among the plurality of items are displayed at different positions but have the same or similar attributes, notification information that is a notification of the attributes of the at least two items.

2. The information processing apparatus according to claim 1, wherein the output unit outputs the notification information in response to an operation for setting the attribute of one of the at least two items.

3. The information processing apparatus according to claim 1, wherein the notification information includes first notification information that is a notification stating that it is possible to allow the at least two items to be displayed at different positions.

4. The information processing apparatus according to claim 3, wherein the first notification information is information that is a notification stating that it is possible to allow the at least two items to be displayed at different positions by changing the attribute of any one of the at least two items.

5. The information processing apparatus according to claim 4, wherein the display unit displays the one of the at least two items in a state where the attribute of the one of the at least two items is changeable, in response to an operation with respect to the first notification information.

6. The information processing apparatus according to claim 3, wherein the first notification information is information that is a notification stating that it is possible to allow the at least two items to be displayed at different positions by changing none of the attributes of the at least two items.

7. The information processing apparatus according to claim 1, wherein the notification information includes second notification information that is a notification stating that it is possible not to allow the at least two items to be displayed at different positions.

8. The information processing apparatus according to claim 7, wherein the second notification information is information that is a notification stating that it is possible not to allow the at least two items to be displayed at different positions by integrating several items from among the at least two items.

9. The information processing apparatus according to claim 8, wherein the display unit displays a single item obtained by integrating the several items in response to an operation with respect to the second notification information.

10. The information processing apparatus according to claim 8, wherein the notification information includes information for selecting the several items.

11. A non-transitory computer readable medium storing a program causing a computer to execute a process for information processing, the process comprising:
displaying a relations diagram in which a plurality of items are connected to each other via arrows to represent relations between the plurality of items; and
outputting, if at least two items among the plurality of items are displayed at different positions but have the same or similar attributes, notification information that is a notification of the attributes of the at least two items.

12. An information processing apparatus comprising:
display means for displaying a relations diagram in which a plurality of items are connected to each other via arrows to represent relations between the plurality of items; and
output means for outputting, if at least two items among the plurality of items are displayed at different positions but have the same or similar attributes, notification information that is a notification of the attributes of the at least two items.
